(19) United States
(12) Patent Application Publication
(10) Pub. No.: US 2017/0000676 A1
(43) Pub. Date: Jan. 5, 2017

(54) Operating Table Column

(71) Applicant: MAQUET GMBH, RASTATT (DE)

(72) Inventor: Rolf REVENUS, Kuppenheim (DE)

(73) Assignee: MAQUET GMBH, RASTATT (DE)

(21) Appl. No.: 15/269,562

(22) Filed: Sep. 19, 2016

Related U.S. Application Data
(63) Continuation-in-part of application No. PCT/EP2015/057350, filed on Apr. 2, 2015.

(30) Foreign Application Priority Data
Apr. 2, 2014 (DE) 10 2014 104 681.1

(51) Int. Cl. A61G 13/04; A61G 13/06

(52) U.S. Cl. CPC A61G 13/04; A61G 13/06

(57) ABSTRACT

An operating table column is disclosed. The operating table column has a base body and an inclination body pivotably supported on the base body, the inclination body pivotable about a first pivot axis. The operating table column also has a tilting body pivotably supported on the inclination body, the tilting body pivotable about a second pivot axis, a first actuating drive assembly that pivots the inclination body about the first pivot axis, and a longitudinally extended, second actuating drive assembly that pivots the tilting body about the second pivot axis. The tilting body is attachable to a patient support surface in a support surface plane. The first actuating drive assembly is connected to the base body and to the inclination body.

### CROSS REFERENCE TO RELATED APPLICATIONS

The present application is a continuation-part filed under 35 U.S.C. §111(a), and claims the benefit under 35 U.S.C. §§365(c) and 371 of PCT International Application No. PCT/EP2015/057350, filed Apr. 2, 2015, and which designates the United States of America, and German Patent Application No. 10 2014 104 681.1, filed Apr. 2, 2014. The disclosures of these applications are herein incorporated by reference in their entirety.

### TECHNICAL FIELD

The disclosure relates to an operating table column with a base body, an inclination body supported on the base body and which can pivot about a first pivot axis, and to a tilting body supported on the inclination body and which can pivot about a second pivot axis. Furthermore, the operating table column may comprise a first actuating drive for pivoting the inclination body about the first pivot axis and may comprise a longitudinally extended, second actuating drive for pivoting the tilting body about the second pivot axis. A patient support surface can be attached to the tilting body in a support surface plane. The first actuating drive is connected to the base body and to the inclination body and the second actuating drive is pivotably connected in a first connection area to the inclination body and pivotably connected in a second connection area to the tilting body.

### BACKGROUND

Before and during an operation on a patient supported on a patient support surface of an operating table the patient support surface is brought into a position which facilitates an operation on the patient. It is typically suitable to pivot the patient support surface through a relatively large angle. Even the height of the patient support surface of the operating table may be adjustable over a relatively large range. The operating table also makes possible relatively small heights of the patient support surface which involves a space-saving construction of the operating table column. In addition, individual elements of the patient support surface can frequently be pivoted out of a support surface plane in order to make a relatively precise adjustment of the lying position of the patient. As a rule, the actuating drives provided for pivoting the patient support surface are part of the operating table column, in contrast to which the individual elements of the patient support surface, which can be adjusted relative to each other, are adjusted by actuating drives arranged in the patient support surface.

Usually three different types of operating tables are used in the operation of a hospital, namely, stationary operating tables, movable operating tables and mobile operating tables. Stationary operating tables have an operating table column which is permanently connected to the floor of an operating room, wherein they usually do not have an operating table foot and are supplied with energy by permanently installed cables. The patient support surface can be readily detached and reconnected in the case of these operating tables and can be moved with a transport device provided to this end. A patient can be transported on the patient support surface in and out of the operating room with this transport device.

Movable operating tables have an operating table foot connected to the operating table column which foot makes possible a free positioning in the operating room. Movable operating tables also typically have a patient support surface which can be detached from the operating table column and reconnected to it. The moving of the operating table column takes place by a column transporter provided to this end or in the case of operating tables which can be moved by themselves by built-in, extensible transport rollers.

Operating table feet of mobile operating tables have rollers for moving the operating table so that they can be moved without additional auxiliary equipment and are suitable for transporting a patient. Furthermore, in mobile operating tables the patient support surface is usually connected to the operating table column and is not separated from the operating table column when used in the hospital.

Components that can usually be moved by an electromotor are provided in stationary operating tables and also in movable operating tables and in mobile operating tables, for example an operating table column that can be moved in its length by an electromotor for changing the height of the patient support surface arranged on the operating table column, an operating table column head that can be adjusted about two orthogonal axes for changing the inclination and the tilting of the patient support surface connected to the operating table column head and/or components of the patient support surface that can be adjusted by an electromotor.

The pivoting of the patient support surface about an axis of rotation is designated as an inclination which is orthogonal to a vertical plane in which the longitudinal axis of the patient support surface runs. A pivoting of the patient support surface about its longitudinal axis or about an axis of rotation parallel to the longitudinal axis of the patient support surface and which lies in a vertical tilting plane containing the longitudinal axis of the patient support surface is designated as a tilting.

In some conventional systems, a tilting cylinder may serve to adjust the tilting of a tilting body that is aligned vertically to a bearing surface plane in the operating table column in which plane a patient support surface can be placed. In particular, the tilting cylinder may also be pivoted upon an adjustment of the inclination and involves much construction space for the pivoting movement. This is disadvantageous when managing the operating table column and may involve an expensive protection of the tilting cylinder from water and dirt. The protection of the tilting cylinder is typically realized by a bellows whose folds are very expensive to clean and disinfect. Without such a protection dirt and liquids would penetrate into the tilting cylinder and make contact with current-conducting structural components.

### SUMMARY OF THE DISCLOSURE

The present disclosure involves an operating table column and an operating table which are constructed in a relatively simple and compact manner.

In at least some exemplary embodiments, the second adjusting drive involves less construction space than conventional systems during the inclination of the inclination body and of the tilting body and can be readily covered from above by a patient support surface and by a simply constructed covering, e.g. a box-shaped housing, from the side. As a result, relatively expensive constructions such as bellows for covering the second actuating drive become superfluous. The desired protection of the second actuating drive can be provided in a simple manner as a consequence over the entire adjustment range. In particular, the cleaning and disinfection are simplified.

In at least some exemplary embodiments, a longitudinally extended, second actuating drive can be provided and can be placed directly underneath the tilting body. The longitudinal axis of the second actuating drive can be arranged in such a manner here that it encloses a preferably small angle with an axis parallel to the first pivot axis, e.g., it is arranged approximately parallel to the support surface plane. As a result, the lower end of the second actuating drive travels over a relatively small path upon a pivoting of the inclination body and is not pivoted into the active area of the user. For example, it may not be appropriate for a user's hands to be disposed on the second actuating drive (e.g., clamped in).

The term support surface plane denotes a plane in the following which is defined by the part of the patient support surface which is attached to the tilting body. For example, the patient support surface can also comprise support surface parts, e.g. pivotable leg plates and/or back plates which can be adjusted relative to the part, defining a support surface plane, of the patient support surface attached to the tilting body.

A first longitudinal end of the longitudinally extended, second actuating drive may be provided as the first connecting area. The second connecting area may be provided by the second longitudinal end of the second actuating drive opposite the first longitudinal end.

In at least some exemplary embodiments, the pivotable support of the inclination body on the base body and the pivotable support of the tilting body on the inclination body together may form a Cardanic support of the tilting body on the base body. This may achieve a high rigidity of the support of the tilting body on the base body.

In at least some exemplary embodiments, the pivot axis of the pivotable support of the second actuating drive on the inclination body and the pivot axis of the pivotable support of the second actuating drive on the tilting body may be parallel to the second pivot axis. As a result, a decoupling of the tilting adjustment from the inclination adjusting and an adjustability of the second adjusting drive over a large angle range may be achieved.

Furthermore, in at least some exemplary embodiments, the second actuating drive may be arranged during an adjusting movement inside its adjusting range (e.g., within a predetermined adjusting range) completely below the tilting body. As a result, the second actuating drive may be covered from above by the patient support surface. This may simplify the screening of the second actuating drive.

Furthermore, in at least some exemplary embodiments, the longitudinal axis of the second actuating drive may enclose an acute angle with the support surface plane. As a result, the second actuating drive may not be pivoted so far outward from the area of the tilting body upon an adjustment of inclination.

In at least some exemplary embodiments, the acute angle may be between 5 degrees and 60 degrees. The acute angle may be for example between 10 degrees and 50 degrees such as, for example, between 12 degrees and 25 degrees. The smaller the previously cited angle is, the compacter (e.g., more compact) the screening of the longitudinally extended, second actuating drive directly underneath the patient support surface can be realized. The greater this angle is, the more efficiently the force exerted by the second actuating drive in the direction of its longitudinal axis can be converted into a sufficiently strong torque (e.g., to pivot the tilting body).

In at least some exemplary embodiments, the first actuating drive and/or the second actuating drive may be linear actuating drives. As a result, the force involved to pivot the tilting body is made available with relatively simple technical techniques. The first actuating drive and/or the second actuating drive may be constructed as lifting cylinders.

In at least some exemplary embodiments, the second actuating drive may be at least partially covered by a rigid covering arranged underneath the patient support surface. Such a rigid covering can be easily cleaned and disinfected and may not hinder the freedom of movement of the user.

Furthermore, in at least some exemplary embodiments, the inclination body may comprise a first bearing bush and a second bearing bush for receiving and rotatably supporting a rod connected to the tilting body, wherein the rod may form the second pivot axis. As a consequence, the rod may transfer an adjustment of inclination of the inclination body onto the tilting body and may form at the same time together with the bearing bushes a pivotable support of the tilting body about the second pivot axis. As a result of this construction, the tilting body may be stable and supported in a relatively simple manner on the inclination body.

In at least some exemplary embodiments, the inclination body may have a first projection and a second projection which are each directed onto the patient support surface. The first bearing bush is a first passage hole constructed in the first projection and the second bearing bush is a second passage hole constructed in the second projection. As a result, the distance of the second pivot axis from a patient support surface connected to the tilting body may be (e.g., advantageously) small. This distance may be approximately between 1 cm and 6 cm. As a result of the distance selected to be relatively small, the patient support surface may execute a horizontal movement which is relatively small upon a tilting adjustment.

A first frame forming the inclination body and a second frame forming the tilting body may be provided. As a result, a relatively high stability of the inclination body and of the tilting body and a simple construction may be achieved.

In at least some exemplary embodiments, the operating table column may have a telescopic construction with at least two column elements which can be shifted relative to each other along a common longitudinal axis (e.g., are shiftable relative to each other along a common longitudinal axis). The inclination body may be supported here on a first one of the at least two column elements in such a manner that it can pivot about the first pivot axis. The first end of the first actuating drive may be pivotably connected to the first column element. As a result, the inclination adjustment and the tilting adjustment may be decoupled from a height adjustment that can be achieved by the column elements which can shift relative to each other. In addition, the first actuating drive may be arranged very closely to the first column element since the high forces acting vertically on the first actuating drive may be introduced over short paths into the first column element.

Furthermore, in at least some exemplary embodiments, the inclination body may be surrounded in the neutral position of the tilting body by the tilting body in the support surface plane and the first column element may be surrounded by the inclination body in the support surface plane. As a result, the required construction space may be minimized in the operating table column and a distinctly lower construction height of the operating table column may be achieved with an adjustment range which continues to be large. A neutral position of the tilting body may occur when the support surface plane is parallel to the cross-sectional surface of the inclination body. This is met, for example, if a patient support surface attached to the tilting body is horizontally arranged.

Furthermore, in at least some exemplary embodiments, the first frame and the second frame may be rectangular. This can achieve a relatively high degree of stiffness of the construction group composed by the tilting body and the patient support surface.

In at least some exemplary embodiments, the first pivot axis may be substantially vertical to the second pivot axis or to an axis parallel to the second pivot axis. Furthermore, the first pivot axis may run through a first side of the tilting body and through a second side of the tilting body opposite the first side. The second pivot axis may run through a third side of the tilting body and through a fourth side of the tilting body opposite the third side. This may allow for a stable construction such as, for example, a Cardanic support.

### BRIEF DESCRIPTION OF THE DRAWINGS

Other features and advantages of the disclosed apparatus and method may result from the following description using exemplary embodiments in combination with the attached figures. In the figures:

FIG. 1 Shows a side view of an exemplary operating table column;

FIG. 2 Shows a detailed perspective view of the operating table column according to FIG. 1;

FIG. 3 Shows a side view of the operating table column according to FIG. 1 from another side;

FIG. 4 Shows a perspective side view of an operating table column according to an exemplary embodiment, wherein parts of the operating table column are omitted;

FIG. 5 Shows a perspective view of an operating table with the operating table column shown in FIG. 4.

### DETAILED DESCRIPTION AND INDUSTRIAL APPLICABILITY

FIG. 1 shows a lateral view of an operating table column 10. The operating column 10 may comprise a base body 12 comprising three column elements 13a, 13b, 13c which can be shifted into each other telescopically. A tilting body 14 may be arranged in an area 25 on the upper end of the first column elements 13a. The tilting body 14 may comprise a bearing bush 24 in which a bolt is received which is not shown and is supported in such a manner that it can rotate about a tilting axis.

A support element 16 may be fastened on an inclination body 26 to which element a tilting cylinder 18 is connected. The tilting cylinder 18 may comprise a cylinder tube 20 and a piston rod 22, wherein the cylinder tube 20 may be pivotably connected at its lower end to the support element 16 and the piston rod 22 is connected by its upper end to the tilting body 14. The tilting cylinder 18 may be vertically arranged in the represented neutral position of the inclination body 26 and of the tilting body 14.

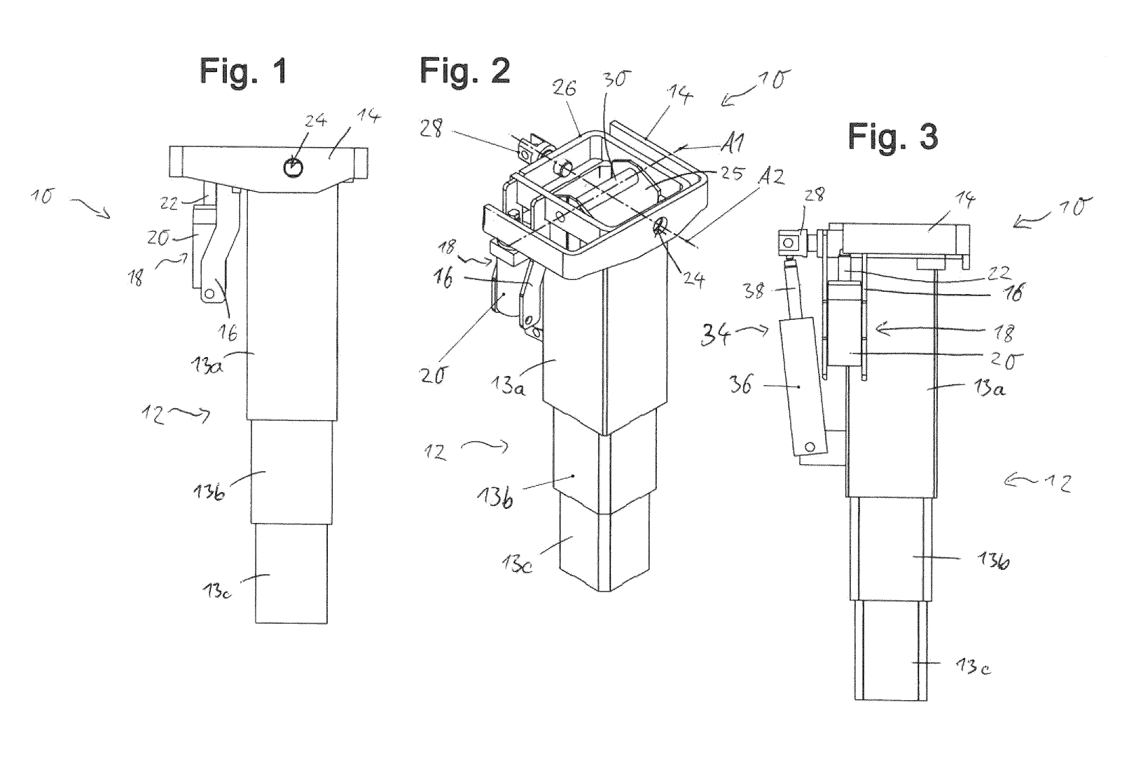

FIG. 2 shows a perspective view of the operating table column 10 according to FIG. 1. In the area 25 of the column element 13a the inclination body 26 may be pivotably supported about a first pivot axis A1 designated in the following as the inclination axis. To this end a pivot bolt 30 may be permanently connected to the inclination body 26 and may be received in two openings in the area 25 and may be slidingly supported. The inclination body 26 may be pivoted via a first actuating drive assembly (e.g., lifting cylinder 34 shown in FIG. 3) and connected to a fork 28, which cylinder is designated in the following as an inclination cylinder.

The tilting body 14 may be pivotably supported on the inclination body 26 by a pivot bolt received in the bearing bush 24 and about a second pivot axis A2 designated in the following as a tilting axis.

The support element 16 may be constructed in such a manner that the area of the cylinder tube 20 connected to the support element 16 and the area of the piston rod 22 connected to the tilting body 14 lie on the same side of a vertical tilting plane running through the tilting axis A2.

FIG. 3 is a lateral view which shows the operating table column from a side different than in FIG. 1. Here, the inclination cylinder 34 serving to adjust the inclination may be visible with its cylinder tube 36 and its piston rod 38. The cylinder tube 36 may be pivotably connected to the column element 13a and the piston rod 38 to the fork 28.

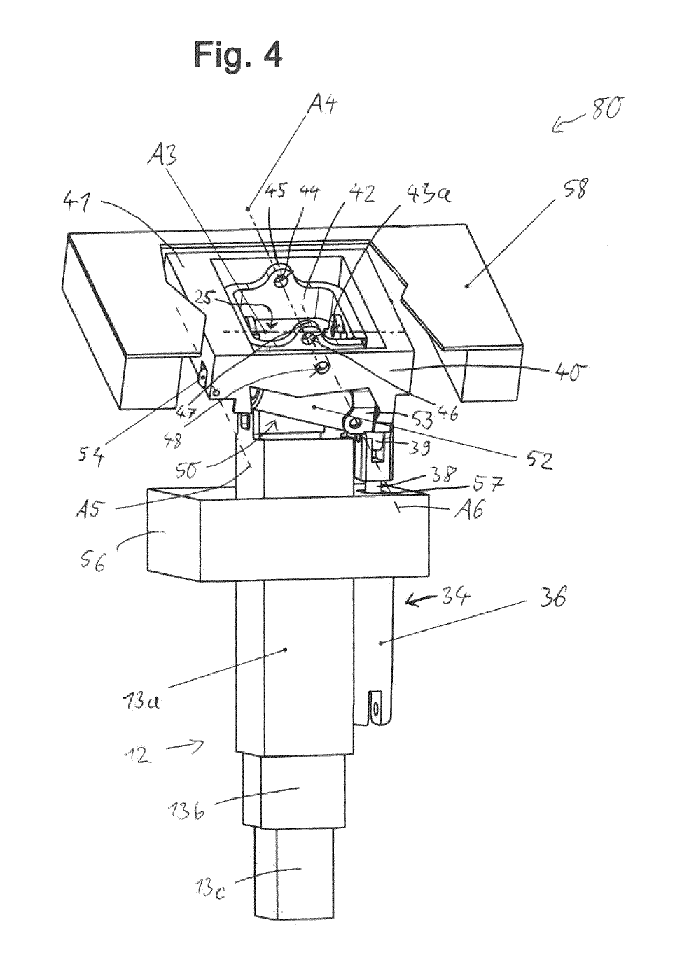

FIG. 4 shows a perspective view of an operating table column 80 according to another exemplary embodiment. The operating table column 80 may comprise an inclination body 42 supported in the upper area 25 of the first column element 13a in such a manner that it can pivot about an inclination axis A3 and comprises a tilting body 40 supported on the inclination body 42 around a tilting axis A4.

The tilting body 40 may be connected by a longitudinally extended, second actuating drive assembly (e.g., tilting cylinder 50) to the inclination body 42. The tilting cylinder 50 may comprise a cylinder tube 52 and a piston rod 54 received in the cylinder tube 52 in such a manner that it can shift in its longitudinal direction. The end of the cylinder tube 52, which may be opposite the end of the piston rod 54 projecting out of the cylinder tube 52, may be connected to a support element 53 of the inclination body 42 in such a manner that it can pivot about a first pivot axis A6 (e.g., a fourth pivot axis of a pivotable support of a second actuating drive). The end of the piston rod 54 projecting out of the cylinder tube 52 may be connected to the tilting body 40 in such a manner that it can pivot about a second pivot axis A5 (e.g., a third pivot axis of a pivotable support of a second actuating drive). The end of the cylinder tube 52 may be connected to the support element 53 that lies on one side of a vertical tilting plane containing the tilting axis A4 and the end of the piston rod 54 connected to the tilting body 40 lies on the other side of the tilting plane.

The ends of the tilting cylinder 50 may remain inside their adjustment range on their particular side of the tilting plane during an adjustment of the tilting cylinder 50 and/or during an adjustment of the inclination cylinder 34. The longitudinal axis of the tilting cylinder 50 may form an acute angle with the support surface plane lying parallel to a plane defined by the support surface 41 of the tilting body 40. The tilting cylinder 50 may be arranged over its entire adjustment range of approximately parallel to the support surface plane underneath the patient support surface 58. Therefore, the tilting cylinder 50 may be covered by the patient support surface 58 during upward pivotings of the inclination body 42 and of the tilting body 40.

The cylinder tube 36 of the inclination cylinder 34 may be connected by a bolt to the first column element 13a. The piston rod 38 of the inclination cylinder 34 may be pivotably connected to a flap 39 which for its part is pivotably coupled to the inclination body 42.

A first bearing bush 43a and a second bearing bush may be constructed in the upper area of the column element 13a. A pivot bolt may be received in each of these bearing bushes 43a about which the inclination body 42 is rotatably supported. The pivot axis defined by the pivot bolts may form the axis of inclination A3 of the inclination body 42.

The inclination body 42 may comprise a first projection 45 and a second projection 47 which may both be directed upward and in which a third bearing bush 44 and a fourth bearing bush 46 may be constructed as passage holes.

A first passage hole 48 located on the tilting axis A4 and a second passage hole may be formed in the tilting body 40 surrounding the inclination body 42 in a plane parallel to the support surface plane. A rod may be received in these passage holes 48 and the bearing bushes 44, 46 which may form the tilting axis A4. The rod may be permanently connected to the passage holes 48 and rotatably supported in the third and the fourth bearing bushes 44, 46. Furthermore, a vertical force intended for the height adjustment of the first column element 13a may be introduced on this rod.

The inclination cylinder 34 and the base body 12 may be partially covered by a covering 56 schematically shown in FIG. 4. The inclination cylinder 34 may run through a longitudinal hole 57 of the covering 56.

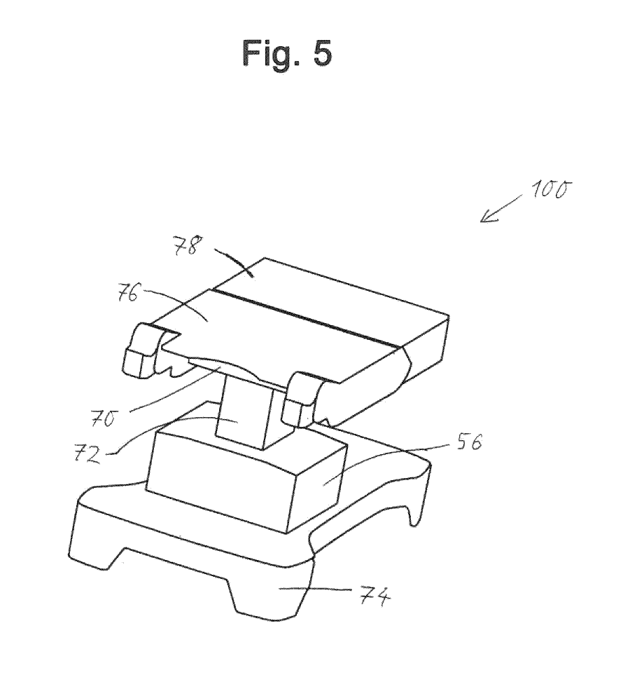

FIG. 5 shows a perspective view of an operating table with the operating table column 80 shown in FIG. 4. A rigid cover (e.g., a rigid box 70) in which the tilting cylinder 50 may be received may be arranged parallel to the support surface plane underneath the patient support surface 58 and may be connected to the tilting body 40. As a result, the tilting cylinder 50 may be protected laterally (e.g., and downward box 70 for example also protected) against actions from the outside. The column elements 13a to 13c may be protected by another covering 72 arranged above the covering 56. The covering 56 may be seated on a column foot 74.

The patient support surface 58 may comprise several segments which can pivot against each other, of which, for example, two segments are shown in FIG. 5 illustrating exemplary operating table 100.

It will be apparent to those skilled in the art that various modifications and variations can be made to the disclosed method and apparatus. Other embodiments will be apparent to those skilled in the art from consideration of the specification and practice of the disclosed method and apparatus. It is intended that the specification and the disclosed examples be considered as exemplary only, with a true scope being indicated by the following claims.

What is claimed is:

1. An operating table column, comprising:
a base body;
an inclination body pivotably supported on the base body, the inclination body pivotable about a first pivot axis;
a tilting body pivotably supported on the inclination body, the tilting body pivotable about a second pivot axis;
a first actuating drive assembly that pivots the inclination body about the first pivot axis; and
a longitudinally extended, second actuating drive assembly that pivots the tilting body about the second pivot axis;
wherein the tilting body is attachable to a patient support surface in a support surface plane;
wherein the first actuating drive assembly is connected to the base body and to the inclination body;
wherein the second actuating drive assembly is pivotably connected in a first connection area to the inclination body and is pivotably connected in a second connection area to the tilting body; and
wherein the second actuating drive assembly is disposed relative to a tilting plane, which is substantially vertical to the support surface plane and contains the second pivot axis, such that the first connection area connected to the inclination body is at a first distance from the tilting plane on a first side of the tilting plane, and the second connection area connected to the tilting body is at a second distance from the tilting plane on a second side of the tilting plane.

2. The operating table column according to claim 1, wherein the pivotable support of the inclination body on the base body and the pivotable support of the tilting body on the inclination body together form a Cardanic support of the tilting body on the base body.

3. The operating table column according to claim 1, wherein a third pivot axis of the pivotable support of the second actuating drive on the inclination body and a fourth pivot axis of the pivotable support of the second actuating drive on the tilting body are parallel to the second pivot axis.

4. The operating table column according to claim 1, wherein the second actuating drive assembly is arranged during an adjusting movement within a predetermined adjusting range completely below the tilting body.

5. The operating table column according to claim 1, wherein the longitudinal axis of the second actuating drive assembly encloses an acute angle with the support surface plane.

6. The operating table column according to claim 5, wherein the acute angle is between 5° and 60°.

7. The operating table column according to claim 1, wherein at least one of the first actuating drive assembly and the second actuating drive assembly is a linear actuating drive assembly.

8. The operating table column according to claim 1, wherein the second actuating drive assembly is at least partially surrounded by a rigid cover.

9. The operating table column according to claim 8, wherein:
the inclination body has a first projection and a second projection that are each directed onto the patient support surface; and
the first bearing bush is a first passage hole disposed in the first projection and the second bearing bush is a second passage hole disposed in the second projection.

10. An operating table column, comprising:
a base body;
an inclination body pivotably supported on the base body, the inclination body pivotable about a first pivot axis;
a tilting body pivotably supported on the inclination body, the tilting body pivotable about a second pivot axis;
a first actuating drive assembly that pivots the inclination body about the first pivot axis; and
a second actuating drive assembly that pivots the tilting body about the second pivot axis;
wherein the tilting body is attachable to a patient support surface in a support surface plane;
wherein the first actuating drive assembly is connected to the base body and to the inclination body;
wherein the second actuating drive assembly is pivotably connected to the inclination body and to the tilting body; and
wherein the pivotable support of the inclination body on the base body and the pivotable support of the tilting body on the inclination body together form a Cardanic support of the tilting body on the base body.

11. The operating table column according to claim 10, wherein the inclination body is a first frame and the tilting body is a second frame.

12. The operating table column according to claim 11, wherein the first frame and the second frame are rectangular.

13. The operating table column according to claim 10, wherein:
the operating table column has a telescopic construction with at least two column elements that are shiftable relative to each other along a common longitudinal axis; and
the inclination body is supported on a first one of the at least two column elements so that the inclination body is pivotable about the first pivot axis and the first end of the first actuating drive assembly is pivotably connected to the first column element.

14. The operating table column according to claim 13, wherein:
the inclination body is surrounded in a neutral position of the tilting body by the tilting body in the support surface plane; and
the first column element is surrounded by the inclination body in the support surface plane.

15. The operating table column according to claim 10, wherein:
the first pivot axis is substantially vertical to the second pivot axis or to an axis parallel to the second pivot axis;
the first pivot axis runs through a first side of the tilting body and through a second side of the tilting body that is opposite to the first side; and
the second pivot axis runs through a third side of the tilting body and through a fourth side of the tilting body that is opposite to the third side.

16. An operating table, comprising:
a patient support surface;
a base body;
an inclination body pivotably supported on the base body, the inclination body pivotable about a first pivot axis;
a tilting body pivotably supported on the inclination body, the tilting body pivotable about a second pivot axis;
a first actuating drive assembly that pivots the inclination body about the first pivot axis; and
a second actuating drive assembly that pivots the tilting body about the second pivot axis;
wherein the tilting body is attachable to the patient support surface in a support surface plane;
wherein the first actuating drive assembly is connected to the base body and to the inclination body;
wherein the second actuating drive assembly is pivotably connected in a first connection area to the inclination body and is pivotably connected in a second connection area to the tilting body; and
wherein the second actuating drive assembly is disposed relative to a tilting plane, which is substantially vertical to the support surface plane and contains the second pivot axis, such that the first connection area connected to the inclination body is at a first distance from the tilting plane on a first side of the tilting plane, and the second connection area connected to the tilting body is at a second distance from the tilting plane on a second side of the tilting plane.

17. The operating table according to claim 16, wherein the pivotable support of the inclination body on the base body and the pivotable support of the tilting body on the inclination body together form a Cardanic support of the tilting body on the base body.

18. The operating table according to claim 16, wherein a third pivot axis of the pivotable support of the second actuating drive on the inclination body and a fourth pivot axis of the pivotable support of the second actuating drive on the tilting body are parallel to the second pivot axis.

19. The operating table according to claim 16, wherein the second actuating drive assembly is arranged during an adjusting movement within a predetermined adjusting range completely below the tilting body.

20. The operating table according to claim 16, wherein the longitudinal axis of the second actuating drive assembly encloses an acute angle with the support surface plane.
